(19) United States
(12) Patent Application Publication
(10) Pub. No.: US 2015/0321328 A1
(43) Pub. Date: Nov. 12, 2015

(54) GAS NAIL GUN AND GAS CONTAINER DRIVING DEVICE THEREOF

(71) Applicant: BASSO INDUSTRY CORP., Taichung (TW)

(72) Inventors: An-Gi LIU, Taichung (TW); Guey-Horng LIOU, Taichung (TW)

(21) Appl. No.: 14/702,890

(22) Filed: May 4, 2015

(30) Foreign Application Priority Data
May 8, 2014 (TW) 103208046

(51) Int. Cl. B25C 1/08; B25C 7/00; B25C 1/00

(52) U.S. Cl. CPC B25C 1/08; B25C 1/008; B25C 7/00

(57) ABSTRACT

A gas container driving device for use in a gas nail gun includes a main body and a cap member. The main body is connected to a gun body of the gas nail gun and has a lever section. When a sleeve is moved relative to the gun body for sealing a combustion chamber, the lever section is pushed and moved by the sleeve to push a gas container received in a receiving space of the gun body for releasing gas into the combustion chamber. The cap member is pivoted to the main body and engages removably the gun body for sealing the receiving space during operation of the main body.

### CROSS-REFERENCE TO RELATED APPLICATION

This application claims priority of Taiwanese Application No. 103208046, filed on May 8, 2014.

### FIELD

The disclosure relates to a nail gun, and more particularly to a gas nail gun and a gas container driving device thereof.

### BACKGROUND

Referring to FIGS. 1 and 2, a conventional gas nail gun 1 includes a gun body 11, a cylinder 12, a sleeve 13, a safety member 14, a gas container 15 and a gas container driving member 17. The gun body 11 is formed with a receiving space 16 extending in an A-direction (A) and opening at a rear end portion of the gun body 11. The cylinder 12 is disposed in the gun body 11. The sleeve 13 cooperates with the gun body 11 and the cylinder 12 to define a combustion chamber 18 thereamong, and is movable relative to the gun body 11 and the cylinder 12 in the A-direction (A) between a first position where the combustion chamber 18 is unsealed, and a second position where the combustion chamber 18 is sealed. The safety member 14 is connected co-movably to the sleeve 13 and disposed adjacent to a front end portion of the gun body 11 for being pressed. The gas container 15 is received in the receiving space 16 and has a valve rod (not shown). The valve rod is movable in the gun body 11 for releasing gas from the gas container 15 when being pressed. The gas container driving member 17 is pivoted to the gun body 11 for sealing the receiving space 16, is aligned with an urging portion 131 of the sleeve 13 in the A-direction, and has a push portion 171 that is disposed at one side of the gas container 15 opposite to the combustion chamber 18.

When the safety member 14 is pressed against a workpiece (not shown) to move the sleeve 13 from the first position to the second position, the urging portion 131 of the sleeve 13 pushes and rotates the gas container driving member 17 to move the push portion 171 to push the gas container 15, so as to move the valve rod relative to the gun body 11, so that the gas is released from the gas container 15 and into the sealed combustion chamber 18 for being ignited.

However, when the gas container driving member 17 of the conventional gas nail gun 1 is rotated by the sleeve 13, a gap 110 (see FIG. 2) is formed between the gas container driving member 17 and the rear end portion of the gun body 11. As a result, environmental powdery dust may easily enter the gun body 11 through the gap 110 to affect operation of the conventional gas nail gun 1.

### SUMMARY

Therefore, an object of the disclosure is to provide a gas container driving device for use in a gas nail gun that can overcome the aforesaid drawback associated with the prior art.

According to the disclosure, a gas container driving device is for use in a gas nail gun. The gas nail gun includes a gun body that is formed with a receiving space extending in an X-direction and opening at a rear end portion of the gun body, a cylinder that is disposed in the gun body, a sleeve that cooperates with the gun body and the cylinder to define a combustion chamber thereamong and that is movable relative to the gun body and the cylinder in the X-direction between a first position where the combustion chamber is unsealed, and a second position where the combustion chamber is sealed, a safety member that is connected co-movably to the sleeve and that is disposed adjacent to a front end portion of the gun body for being pressed, and a gas container that is received in the receiving space and that has a valve rod. The valve rod is movable in the gun body for releasing gas from the gas container when being pressed. The gas container driving device includes a main body and a cap member. The main body has a connecting section that is connected to the gun body, and a lever section that has a control part and a push part. The control part is disposed in the receiving space and contactable with the sleeve. The push part is disposed at one side of the gas container opposite to the combustion chamber. When the sleeve is moved from the first position to the second position, the control part is pushed by the sleeve to drive the push part to push the gas container so as to move the valve rod relative to the gun body, so that the gas is released from the gas container and into the sealed combustion chamber. The cap member is pivoted to the main body and engages removably the rear end portion of the gun body for sealing the receiving space during operation of the main body.

Another object of the disclosure is to provide a gas nail gun that can overcome the aforesaid drawback associated with the prior art.

According to the disclosure, a gas nail gun includes a gun body, a cylinder, a sleeve, a safety member, a gas container and a gas container driving device. The gun body is formed with a receiving space that extends in an X-direction and that opens at a rear end portion of the gun body. The cylinder is disposed in the gun body. The sleeve cooperates with the gun body and the cylinder to define a combustion chamber thereamong, and is movable relative to the gun body and the cylinder in the X-direction between a first position where the combustion chamber is unsealed, and a second position where the combustion chamber is sealed. The safety member is connected co-movably to the sleeve and disposed adjacent to a front end portion of the gun body for being pressed. The gas container is received in the receiving space and has a valve rod. The valve rod is movable in the gun body for releasing gas from the gas container when being pressed. The gas container driving device includes a main body and a cap member. The main body has a connecting section that is connected to the gun body, and a lever section that has a control part and a push part. The control part is disposed in the receiving space and contactable with the sleeve. The push part is disposed at one side of the gas container opposite to the combustion chamber. When the sleeve is moved from the first position to the second position, the control part is pushed by the sleeve to drive the push part to push the gas container so as to move the valve rod relative to the gun body, so that the gas is released from the gas container and into the sealed combustion chamber. The cap member is pivoted to the main body and engages removably the rear end portion of the gun body for sealing the receiving space during operation of the main body.

### BRIEF DESCRIPTION OF THE DRAWINGS

Other features and advantages of the disclosure will become apparent in the following detailed description of the embodiment with reference to the accompanying drawings, of which:

FIG. 1 is a sectional view of a conventional gas nail gun;

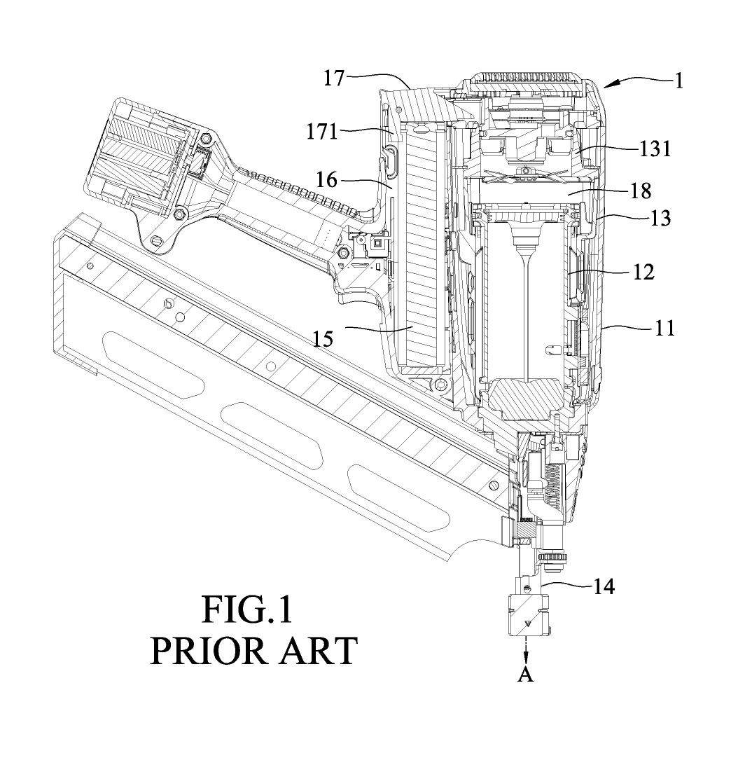

FIG. 2 is a fragmentary sectional view of the conventional gas nail gun;

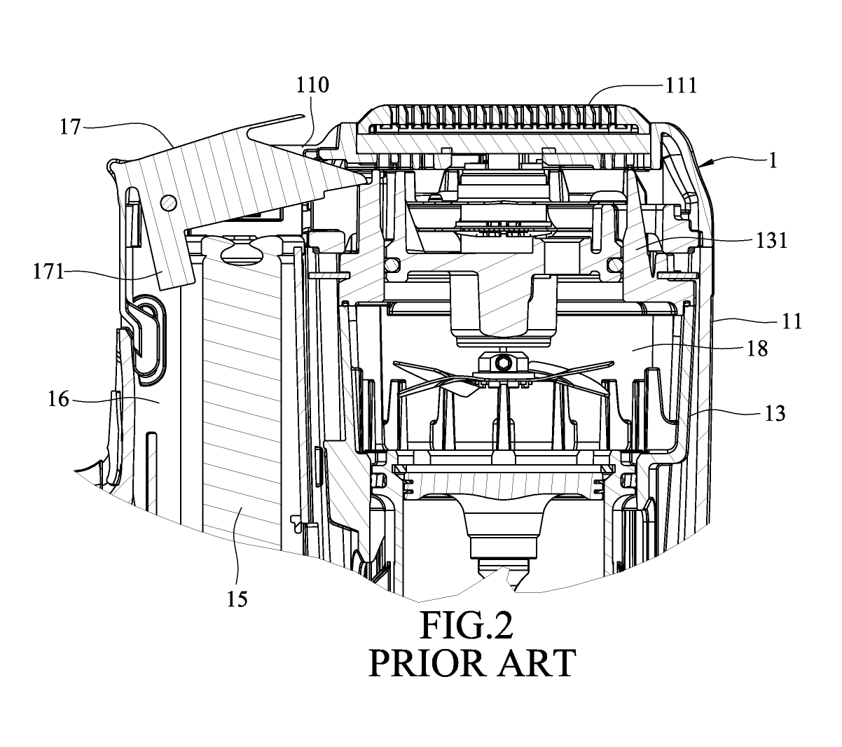

FIG. 3 is a side view of an embodiment of a gas nail gun according to the disclosure;

FIG. 4 is an exploded perspective view of a gas container driving device of the embodiment;

FIG. 5 is a schematic fragmentary sectional view of the embodiment;

FIG. 6 is a fragmentary sectional view of the embodiment;

FIG. 7 is a side view of the embodiment illustrating a safety member being pressed;

FIG. 8 is another fragmentary sectional view of the embodiment illustrating a main body of the gas container driving device being pushed; and

FIG. 9 is still another fragmentary sectional view of the embodiment illustrating a valve rod of a gas container is pressed.

### DETAILED DESCRIPTION

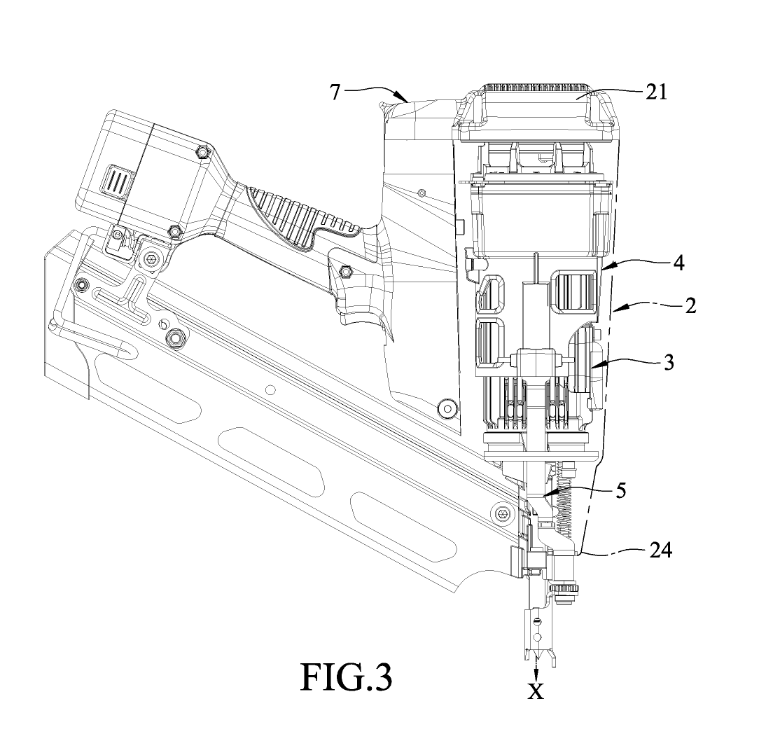

Referring to FIGS. 3 to 5, an embodiment of a gas nail gun according to the disclosure includes a gun body 2, a cylinder 3, a sleeve 4, a safety member 5, a gas container 6 and a gas container driving device 7.

The gun body 2 is formed with a receiving space 22 that extends in an X-direction (X) and that opens at a rear end portion 21 of the gun body 2.

The cylinder 3 is disposed fixedly in the gun body 2.

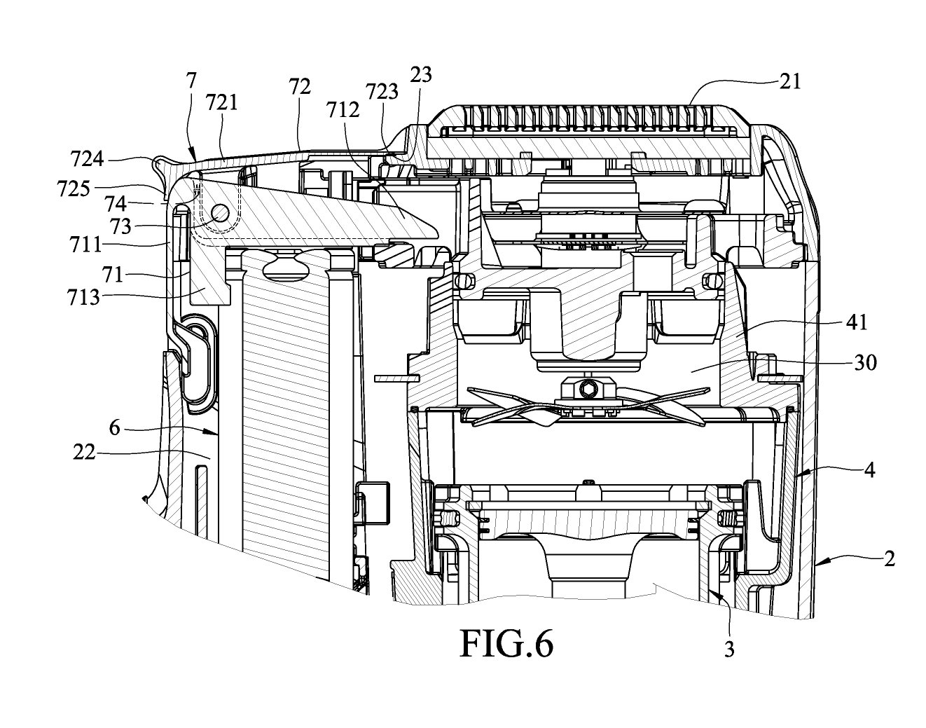

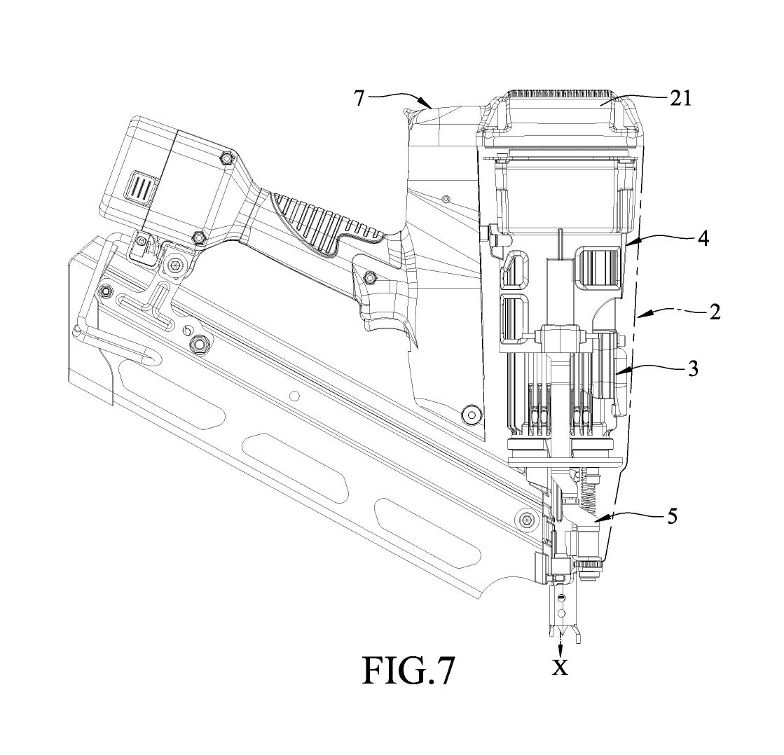

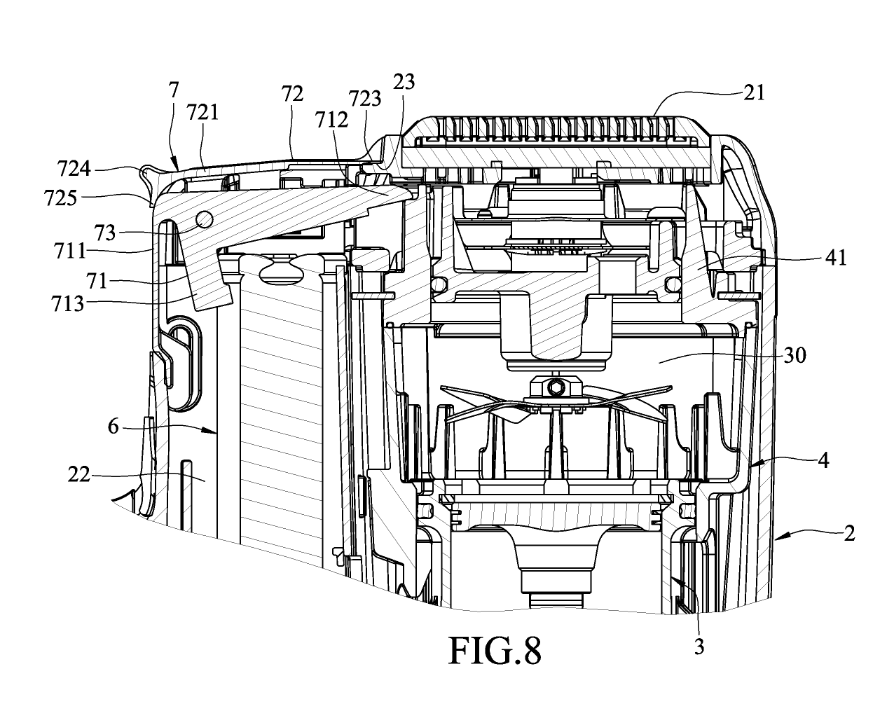

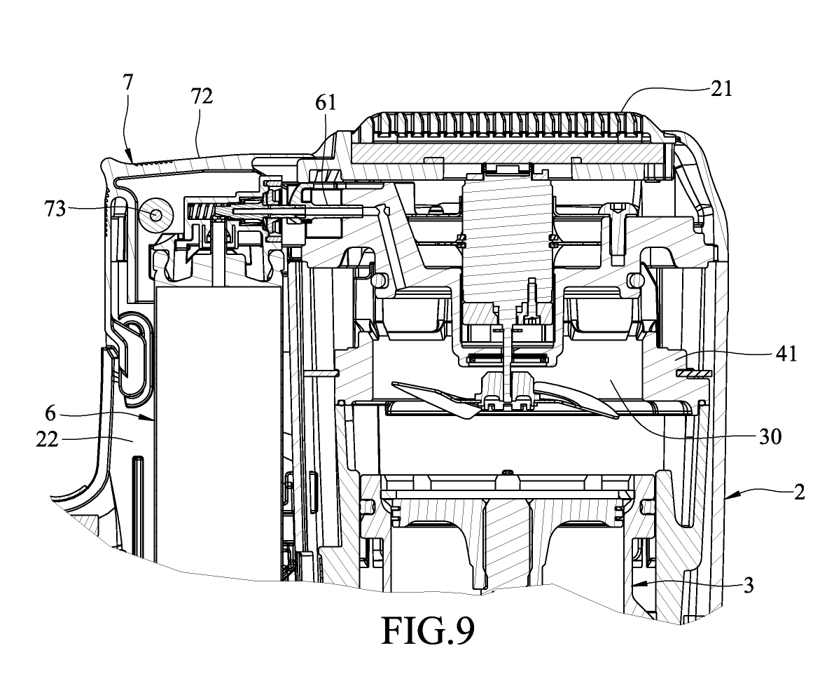

The sleeve 4 is disposed in the gun body 2, cooperates with the gun body 2 and the cylinder 3 to define a combustion chamber 30 thereamong, and is movable relative to the gun body 2 and the cylinder 3 in the X-direction (X) between a first position (see FIGS. 3 and 6) where the combustion chamber 30 is unsealed, and a second position (see FIGS. 7, 8 and 9) where the combustion chamber 30 is sealed. The sleeve 4 has an urging portion 41 disposed adjacent to the rear end portion 21 of the gun body 2.

The safety member 5 is connected co-movably to the sleeve 4 and disposed adjacent to a front end portion 24 of the gun body 2 for being pressed.

The gas container 6 is received in the receiving space 22, and has a valve rod 61. The valve rod 61 is disposed adjacent to the combustion chamber 30, and is movable in the gun body 2 for releasing gas from the gas container 6 when being pressed.

The gas container driving device 7 includes a main body 71, a cap member 72, a pivot shaft 73, two resilient members 74 and an engaging unit.

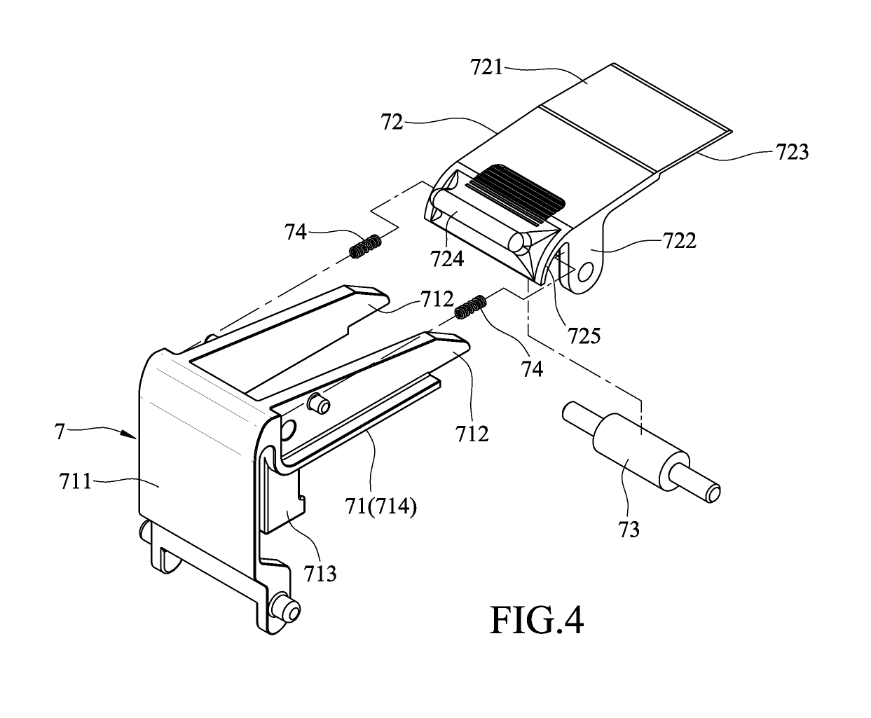

The main body 71 has a connecting section 711 that is connected to the gun body 2, and a lever section 714 that has two control parts 712 and two push parts 713 (only one is visible in FIG. 4). Each of the control parts 712 is disposed in the receiving space 22, and is aligned with the urging portion 41 of the sleeve 4 in the X-direction (X) for being contactable with the sleeve 4. Each of the push parts 713 extends in the X-direction (X), and is disposed at one side of the gas container 6 opposite to the combustion chamber 30. In this embodiment, the connecting section 711 is made of a resilient material.

The cap member 72 has a plate portion 721, and two spaced-apart lugs 722.

The plate portion 721 is in contact with the rear end portion 21 of the gun body 2 for sealing the receiving space 22.

The lugs 722 respectively extend from two lateral edges of the plate portion 721 in the X-direction (X).

The pivot shaft 73 is disposed in the gun body 2 and extends in a direction perpendicular to the X-direction (X) and through the lugs 722 of the cap member 72 and the lever section 714 of the main body 71, so that the cap member 72 and the lever section 714 of the main body 71 are pivotable relative to each other about the pivot shaft 73.

The engaging unit includes first and second engaging structures 23, 723 respectively formed at an outer surface of the rear end portion 21 of the gun body 2 and a distal end of the plate portion 721 of the cap member 72. In this embodiment, the first engaging structure 23 is configured as a recess, and the second engaging structure 723 is configured as a protrusion and engages removably the first engaging structure 23 for sealing the receiving space 22. In a variation of the embodiment, the engaging unit may be configured as a hook and loop fastener device.

Each of the resilient members 74 has opposite ends connected respectively to the main body 71 and the cap member 72 for biasing resiliently the cap member 72 to contact the rear end portion 21 of the gun body 2 so as to maintain the engagement between the first and second engaging structures 23, 723 for sealing the receiving space 22.

The cap member 72 further has a projection 724 and an abutment portion 725.

The projection 724 is formed on an outer surface of the plate portion 721 of the cap member 72 so as to allow for manual operation.

The abutment portion 725 is formed at an opposite end of the plate portion 721 of the cap member 72 opposite to the second engaging structure 723 and abuts against the connecting section 711 of the main body 71. In this embodiment, the abutment portion 725 is made of a resilient material.

Referring further to FIGS. 7 to 9, when the safety member 5 is pressed against a workpiece (not shown) to move the sleeve 4 from the first position to the second position, the control parts 712 of the lever section 714 of the main body 71 are pushed by the sleeve 4 to drive the push parts 713 to push the gas container 6 so as to move the valve rod 61 relative to the gun body 2, so that the gas is released from the gas container 6 and into the sealed combustion chamber 30 for being ignited. It is noted that, since the cap member 72 is pivotable relative to the lever section 714 of the main body 71 and the second engaging structure 723 engages the first engaging structure 23, the receiving space 22 is sealed during operation of the main body 71 of the gas container driving device 7.

It is further noted that the abutment portion 725 of the cap member 72 deforms when the sleeve 4 is moved from the first position to the second position, and provides a restoring force to the main body 71 when the sleeve 4 is moved from the second position to the first position.

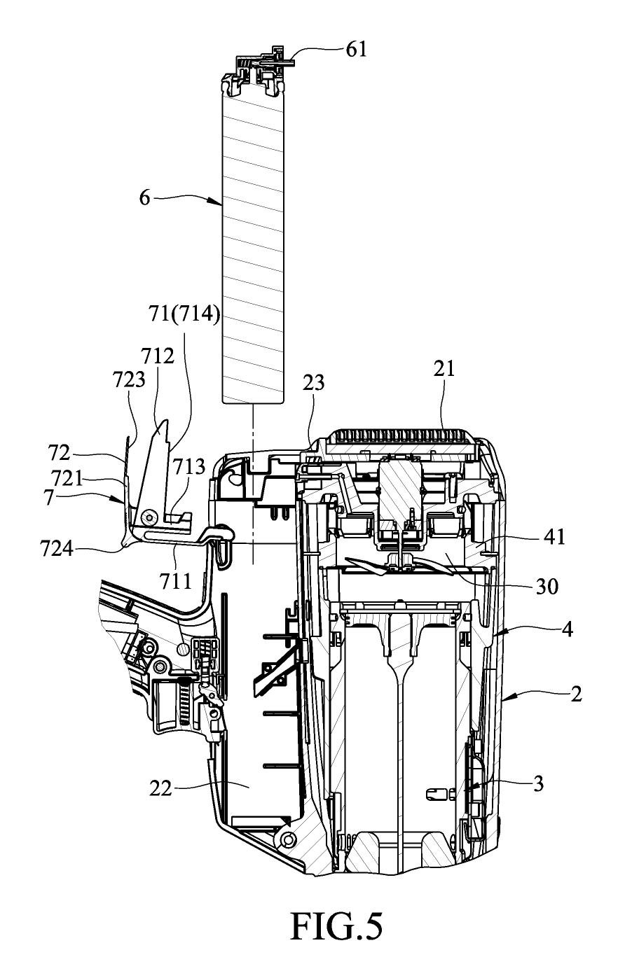

Referring back to FIG. 5, for replacement of the gas container 6, a user can manually pick the projection 724 of the cap member 72 to disengage the second engaging structure 723 from the first engaging structure 23 and to remove the lever section 714 of the main body 71 from the receiving space 22 to open the receiving space 22 for removal of an exhausted gas container 6 and installation of a new gas container 6.

The advantages of this disclosure are as follows:

1. Since the cap member 72 and the lever section 714 of the main body 71 are pivotable relative to each other, the receiving space 22 is kept sealed during operation of the main body 71 for preventing environmental powdery dust from entering the receiving space 22.

2. The configuration of the gas container driving device 7 allows the receiving space 22 to be opened easily so as to facilitate replacement of the gas container 6.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A gas container driving device adapted for use in a gas nail gun, the gas nail gun including a gun body that is formed with a receiving space extending in an X-direction and opening at a rear end portion of the gun body, a cylinder that is disposed in the gun body, a sleeve that cooperates with the gun body and the cylinder to define a combustion chamber thereamong and that is movable relative to the gun body and the cylinder in the X-direction between a first position where the combustion chamber is unsealed, and a second position where the combustion chamber is sealed, a safety member that is connected co-movably to the sleeve and that is disposed adjacent to a front end portion of the gun body for being pressed, and a gas container that is received in the receiving space and that has a valve rod, the valve rod being movable in the gun body for releasing gas from the gas container when being pressed, said gas container driving device comprising:
a main body having a connecting section that is adapted to be connected to the gun body, and a lever section that has a control part and a push part, said control part being adapted to be disposed in the receiving space and contactable with the sleeve, said push part being disposed at one side of the gas container opposite to the combustion chamber, wherein, when the sleeve is moved from the first position to the second position, said control part is pushed by the sleeve to drive said push part to push the gas container so as to move the valve rod relative to the gun body, so that the gas is released from the gas container and into the sealed combustion chamber; and
a cap member pivoted to said main body and adapted to engage removably the rear end portion of the gun body for sealing the receiving space during operation of said main body.

2. The gas container driving device as claimed in claim 1, further comprising at least one resilient member that has opposite ends connected respectively to said main body and said cap member for biasing resiliently said cap member to engage the rear end portion of the gun body.

3. The gas container driving device as claimed in claim 1, further comprising a pivot shaft that is disposed in the gun body and that extends in a direction perpendicular to the X-direction and through said cap member and said lever section of said main body, so that said cap member and said lever section of said main body are pivotable relative to each other about said pivot shaft.

4. The gas container driving device as claimed in claim 1, wherein said cap member has a plate portion in contact with the rear end portion of the gun body for sealing the receiving space, and two spaced-apart lugs extending in the X-direction and pivoted to said lever section of said main body.

5. The gas container driving device as claimed in claim 4, further comprising an engaging unit that includes first and second engaging structures respectively formed at an outer surface of the rear end portion of the gun body and a distal end of said plate portion of said cap member, said second engaging structure being adapted to be movable in the gun body to engage said first engaging structure for sealing the receiving space.

6. The gas container driving device as claimed in claim 4, wherein said cap member further has a projection formed on an outer surface of said plate portion of said cap member so as to allow for manual operation.

7. The gas container driving device as claimed in claim 6, wherein said cap member further has an abutment portion that is formed at an opposite end of said plate portion of said cap member opposite to said second engaging structure and that abuts against said connecting section of said main body, said abutment portion being made of a resilient material for providing a restoring force to said main body when the sleeve is moved from the second position to the first position.

8. The gas container driving device as claimed in claim 1, wherein said connecting section of said main body is made of a resilient material.

9. A gas nail gun comprising:
a gun body formed with a receiving space that extends in an X-direction and that opens at a rear end portion of said gun body;
a cylinder disposed in said gun body;
a sleeve cooperating with said gun body and said cylinder to define a combustion chamber thereamong, and movable relative to said gun body and said cylinder in the X-direction between a first position where said combustion chamber is unsealed, and a second position where said combustion chamber is sealed;
a safety member connected co-movably to said sleeve and disposed adjacent to a front end portion of said gun body for being pressed;
a gas container received in said receiving space and having a valve rod, said valve rod being movable in said gun body for releasing gas from said gas container when being pressed; and
a gas container driving device including a main body and a cap member, said main body having a connecting section that is connected to said gun body, and a lever section that has a control part and a push part, said control part being disposed in said receiving space and contactable with said sleeve, said push part being disposed at one side of said gas container opposite to said combustion chamber, wherein, when said sleeve is moved from the first position to the second position, said control part is pushed by said sleeve to drive said push part to push said gas container so as to move said valve rod relative to said gun body, so that the gas is released from said gas container and into said sealed combustion chamber, said cap member being pivoted to said main body and engaging removably said rear end portion of said gun body for sealing said receiving space during operation of said main body.

10. The gas nail gun as claimed in claim 9, wherein said gas container driving device further includes at least one resilient member that has opposite ends connected respectively to said main body and said cap member for biasing resiliently said cap member to engage said rear end portion of said gun body.

11. The gas nail gun as claimed in claim 9, wherein said gas container driving device further includes a pivot shaft that is disposed in said gun body and that extends in a direction perpendicular to the X-direction and through said cap member and said lever section of said main body, so that said cap member and said lever section of said main body are pivotable relative to each other about said pivot shaft.

12. The gas nail gun as claimed in claim 9, wherein said cap member has a plate portion in contact with said rear end portion of said gun body for sealing said receiving space, and two spaced-apart lugs extending in the X-direction and pivoted to said lever section of said main body.

13. The gas nail gun as claimed in claim 9, wherein said gas container driving device further includes an engaging unit that includes first and second engaging structures respectively formed at an outer surface of said rear end portion of said gun body and a distal end of said plate portion of said cap member, said second engaging structure being movable in said gun body to engage said first engaging structure for sealing said receiving space.
